(19) United States
(12) Patent Application Publication
(10) Pub. No.: US 2023/0263341 A1
(43) Pub. Date: Aug. 24, 2023

(54) Barbecue grill apparatus

(71) Applicant: LEEDARSON LIGHTING CO.,LTD., Zhangzhou (CN)

(72) Inventors: Yao Hong Yeh, Zhangzhou (CN); Zhen Shang Huang, Zhangzhou (CN); Shang Lin, Zhangzhou (CN)

(21) Appl. No.: 18/112,504

(22) Filed: Feb. 22, 2023

(30) Foreign Application Priority Data
Feb. 22, 2022 (CN) 202220363485.0

(51) Int. Cl. A47J 37/07

(52) U.S. Cl. CPC A47J 37/0786; A47J 37/0763; A47J 37/0736

(57) ABSTRACT

A barbecue grill apparatus includes a first folding plate, a second folding plate, a rotating connector and a first heater. The first folding plate has a first top part, a first middle part and a first bottom part. The second folding plate has a second top part, a second middle part and a second bottom part. The rotating connector connects the first bottom part and the second bottom part for the first folding plate and the second folding plate to rotate along the rotating connector to spread with a first angle to be an open mode and to rotate along the rotating connector to collapse with a second angle to a close mode. In the open mode, a grill bracket is placed between the first folding plate and the second folding plate. The first heater placed in the first middle part to emit heat toward the grill bracket.

### FIELD

The present invention is related to a barbecue apparatus, and more particularly related to a barbecue apparatus with electrical heaters.

### BACKGROUND

Barbecue grill devices are popular for several reasons:

Socialization and Entertainment: Barbecue grills are often used in social settings, such as family gatherings and parties, to bring people together and to entertain guests. Grilling can be a fun and interactive way to spend time with family and friends.

Flavor: Grilling can add a unique smoky flavor to food that many people find appealing. The high heat of a grill can also caramelize the sugars in food, creating a crispy exterior and juicy interior.

Convenience: Grilling can be a convenient way to cook food, especially during warmer months when people want to avoid heating up their homes by using ovens or stovetops. Grilling also requires minimal cleanup, as most of the grease and residue are burned off during the cooking process.

Health Benefits: Grilling is often considered a healthier cooking method because it allows excess fat to drip off the food, resulting in lower calorie content. Grilled food can also retain more of its vitamins and minerals than boiled or fried food.

Versatility: Barbecue grills come in a wide range of sizes and styles, from portable models for camping and tailgating to larger, high-end models with multiple burners, rotisseries, and side burners. This versatility allows people to choose the right grill for their needs and to experiment with different cooking techniques and recipes.

Overall, the social, flavorful, convenient, healthy, and versatile aspects of barbecue grilling have made it a popular cooking method for many people around the world.

Charcoal can be dangerous if not used properly. Here are some potential risks associated with charcoal:

Carbon Monoxide Poisoning: Burning charcoal produces carbon monoxide, a colorless and odorless gas that can be lethal in high concentrations. Charcoal should never be used in an enclosed space, such as a garage or tent, as it can quickly build up dangerous levels of carbon monoxide.

Fire Hazard: Charcoal can ignite quickly and produce intense heat, which can lead to fires if not used safely. Improper storage and handling of charcoal can also increase the risk of fire.

Burns: Charcoal can reach extremely high temperatures, and accidental contact with hot coals or the grill itself can result in serious burns.

Inhalation of Particulate Matter: Burning charcoal produces smoke and ash, which can contain small particles that can be inhaled into the lungs. This can lead to respiratory problems, especially in people with preexisting conditions such as asthma.

Chemical Exposure: Some types of charcoal contain additives, such as lighter fluid or chemical binders, that can produce harmful fumes when burned. It's important to choose a high-quality charcoal that is free of these additives and to follow the manufacturer's instructions for safe use.

To minimize these risks, it's important to use charcoal grills in well-ventilated areas, away from combustible materials, and to never leave the grill unattended while it's in use. It's also important to follow the manufacturer's instructions for lighting and extinguishing the charcoal, and to use proper protective gear, such as heat-resistant gloves, when handling hot coals or the grill itself.

Charcoal can be dangerous if not used properly. Here are some potential risks associated with charcoal:

Carbon Monoxide Poisoning: Burning charcoal produces carbon monoxide, a colorless and odorless gas that can be lethal in high concentrations. Charcoal should never be used in an enclosed space, such as a garage or tent, as it can quickly build up dangerous levels of carbon monoxide.

Fire Hazard: Charcoal can ignite quickly and produce intense heat, which can lead to fires if not used safely. Improper storage and handling of charcoal can also increase the risk of fire.

Burns: Charcoal can reach extremely high temperatures, and accidental contact with hot coals or the grill itself can result in serious burns.

Inhalation of Particulate Matter: Burning charcoal produces smoke and ash, which can contain small particles that can be inhaled into the lungs. This can lead to respiratory problems, especially in people with preexisting conditions such as asthma.

Chemical Exposure: Some types of charcoal contain additives, such as lighter fluid or chemical binders, that can produce harmful fumes when burned. It's important to choose a high-quality charcoal that is free of these additives and to follow the manufacturer's instructions for safe use.

To minimize these risks, it's important to use charcoal grills in well-ventilated areas, away from combustible materials, and to never leave the grill unattended while it's in use. It's also important to follow the manufacturer's instructions for lighting and extinguishing the charcoal, and to use proper protective gear, such as heat-resistant gloves, when handling hot coals or the grill itself.

Grilled food tastes delicious for several reasons, including:

Caramelization: When meat or vegetables are grilled, the high heat causes their natural sugars to caramelize and create a crisp, golden-brown crust on the surface. This caramelization adds depth and complexity to the flavor and aroma of the food.

Maillard Reaction: The high heat of the grill also causes a chemical reaction known as the Maillard reaction to occur, which results in the browning of the food's proteins. This reaction creates savory flavors and aromas, adding to the delicious taste of grilled food.

Smoky Flavor: Grilling over charcoal or wood can infuse the food with a delicious smoky flavor that many people find appealing. The smoke can come from the burning of the wood itself or from the fat or juices from the food dripping onto the hot coals and producing smoke.

Fat Dripping: Grilling also allows excess fat to drip off the food, resulting in a leaner and healthier meal. This reduction in fat can also lead to a more intense and concentrated flavor as the remaining fat coats the surface of the food.

Texture: Grilling can produce a variety of textures in food, from a crispy exterior to a juicy and tender interior. This combination of textures can be very satisfying and add to the overall enjoyment of the meal.

Overall, the combination of caramelization, Maillard reaction, smoky flavor, fat dripping, and varied texture combine to make grilled food taste delicious and satisfying to many people.

Therefore, it would beneficial if we can design a convenient tool to perform barbecue while minimizing its drawbacks.

### SUMMARY

In some embodiments, a barbecue grill apparatus includes a first folding plate, a second folding plate, a rotating connector and a first heater.

The first folding plate has a first top part, a first middle part and a first bottom part.

The second folding plate has a second top part, a second middle part and a second bottom part.

The rotating connector connects the first bottom part and the second bottom part for the first folding plate and the second folding plate to rotate along the rotating connector to spread with a first angle to be an open mode and to rotate along the rotating connector to collapse with a second angle to a close mode.

In the open mode, a grill bracket is placed between the first folding plate and the second folding plate.

The first heater placed in the first middle part to emit heat toward the grill bracket.

In some embodiments, the barbecue grill apparatus may also include a second heater placed in the second middle part to emit heat toward the grill bracket.

In some embodiments, a first mesh is placed upon the first heater and a second mesh is placed upon the second heater for heat of the first heater and the second heater to emit heat passing through the first mesh and the second mesh toward the grill bracket.

In some embodiments, the first heater and the second heater receives electrical power to generate heat.

In some embodiments, far-infrared reflecting material is applied on inner side of the first folding plate and the second folding plate.

In some embodiments, the barbecue grill apparatus may also include a first bottom support and a second bottom support respectively disposed on outer side of the first bottom part of the first folding plate and the second bottom part of the second folding plate.

The first bottom support and the second bottom support are extended to stand on a bottom surface to keep a folding space defined by the first folding plate and the second folding plate in the open mode with an opening facing upwardly.

In some embodiments, the first bottom support and the second bottom support are rotated with respect to the first folding plate and the second folding plate to spread for standing on the bottom surface.

In some embodiments, the first bottom support is rotatable to be collected in a first exterior container of the first bottom part of the first folding plate in the close mode.

The second bottom support is routable to be collected in a second exterior container of the second bottom part of the second folding plate in the close mode.

In some embodiments, a first bottom fixing lever has two ends respectively fixed to the first folding plate and the first bottom support and a second bottom fixing lever has two ends respectively fixed to the second folding plate and the second bottom support to keep the first bottom support and the second bottom support to spread.

In some embodiments, the barbecue grill apparatus may also include a bottom plate.

The bottom plate has two wings and a base part.

The two wings are extended from two opposite sides of the base part of the bottom plate.

The two wings respectively leaning on inner sides of the first folding plate and the second folding plate to keep the first folding and the second folding plate to spread in the open mode.

In some embodiments, the base part of the bottom plate is a water tray for holding water.

In some embodiments, two wind shielding plates with trapezoidal shape are placed on two opposite sides of the base part to form an expanding structure to keep the first folding plate and the second folding plate to spread in the open mode.

In some embodiments, the two wind shielding plates are detached from the bottom plate to collapse the bottom plate.

In some embodiments, there are two cavities respectively on top side of the two wind shielding plates for disposing a grill lever.

In some embodiments, the two wings are rotatable with respect to the base part to collapse the bottom plate.

In some embodiments, two elongated holding plates are respectively on inner sides of the two wings.

The grill bracket is placed upon the two elongated holding plates.

In some embodiments, a first inner surface of the first folding plate and a second inner surface of the second folding plate are used for shielding oil dropped on the first inner surface and the second inner surface.

In some embodiments, a temperature sensor is disposed on the first folding plate to detect a grill temperature.

In some embodiments, when a detected temperature of the temperature sensor is larger than a first threshold, the first heater is stopped to be heated.

In some embodiments, in the close mode, the first folding plate and the second folding plate are stacked one another.

### BRIEF DESCRIPTION OF DRAWINGS

FIG. 1 illustrates a barbecue apparatus embodiment in an open mode.

FIG. 2 illustrates the barbecue apparatus embodiment in a close mode.

FIG. 3 illustrates another view of the barbecue apparatus embodiment.

FIG. 4 illustrates an example of a bottom plate.

FIG. 5 illustrates an example showing a grill lever placed on the bottom plate.

FIG. 6 illustrates an example showing a grill net placed upon the base plate.

FIG. 7 illustrates another view of the barbecue embodiment showing the heaters.

FIG. 8 illustrates another bottom plate example.

FIG. 9 shows another barbecue apparatus.

### DETAILED DESCRIPTION

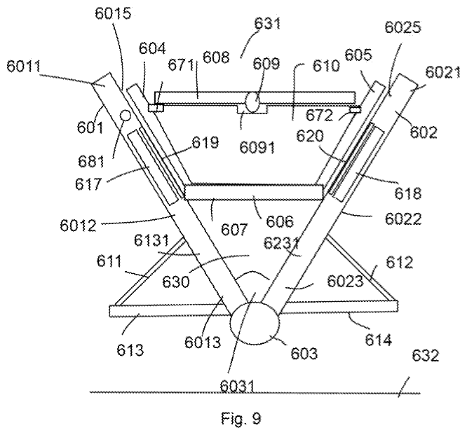

In FIG. 9, a barbecue grill apparatus includes a first folding plate 601, a second folding plate 602, a rotating connector 603 and a first heater 617.

The first folding plate 601 has a first top part 6011, a first middle part 6012 and a first bottom part 6013.

The second folding plate 602 has a second top part 6021, a second middle part 6022 and a second bottom part 6023.

The rotating connector 603 connects the first bottom part 6013 and the second bottom part 6023 for the first folding plate 601 and the second folding plate 602 to rotate along the rotating connector 603 to spread with a first angle 6031 to be an open mode and to rotate along the rotating connector to collapse with a second angle to a close mode.

The rotating connector 603 may be a separate component like a rotation shaft for coupling the first folding plate 601 and the second folding plate 602. In some other embodiments, the rotating connector 603 may be part of one or both of the first folding plate 601 and the second folding plate 602.

In the close mode, the first folding plate 601 is stacked on the second folding plate 602. The grill operation is available in the open mode, in which the first folding plate 601 and the second folding plate 602 are spread with a spreading angle.

In the open mode, a grill bracket 608 is placed between the first folding plate 601 and the second folding plate 602.

The first heater 617 is placed in the first middle part 6012 to emit heat toward the grill bracket 608. The first middle part 6012 and the second middle part 6022 refer to any portion between two ends of the first folding plate 601 and the second folding plate 602.

In some embodiments, the barbecue grill apparatus may also include a second heater 618 placed in the second middle part 6022 to emit heat toward the grill bracket 608.

In some embodiments, a first mesh 619 is placed upon the first heater 617 and a second mesh 620 is placed upon the second heater 618 for heat of the first heater 617 and the second heater 618 to emit heat passing through the first mesh 619 and the second mesh 620 toward the grill bracket. The first mesh 619 and the second mesh 620 have multiple holes for far-infrared lights to pass through the holes to reach the grill bracket 608. In such design, not only air is heated but the far-infrared approach is used for carrying heat to increase heat efficiency.

In some embodiments, the first heater 617 and the second heater 618 receive electrical power to generate heat.

In some embodiments, far-infrared reflecting material 6015, 6025 is applied on inner side of the first folding plate 601 and the second folding plate 602.

In some embodiments, the barbecue grill apparatus may also include a first bottom support 613 and a second bottom support 614 respectively disposed on outer side of the first bottom part 6013 of the first folding plate 601 and the second bottom part 6023 of the second folding plate 602.

The first bottom support 613 and the second bottom support 614 are extended to stand on a bottom surface 632, e.g. a table surface, to keep a folding space 630 defined by the first folding plate 601 and the second folding plate 602 in the open mode with an opening 631 facing upwardly.

In some embodiments, the first bottom support 613 and the second bottom support 614 are rotated with respect to the first folding plate 601 and the second folding plate 602 to spread for standing on the bottom surface 632.

In some embodiments, the first bottom support 613 is rotatable to be collected in a first exterior container 6131 of the first bottom part 6013 of the first folding plate 601 in the close mode.

The second bottom support 614 is rotatable to be collected in a second exterior container 6231 of the second bottom part 614 of the second folding plate 602 in the close mode.

In some embodiments, a first bottom fixing lever 611 has two ends respectively fixed to the first folding plate 601 and the first bottom support 6013 and a second bottom fixing lever 612 has two ends respectively fixed to the second folding plate 602 and the second bottom support 614 to keep the first bottom support 613 and the second bottom support 614 to spread.

In some embodiments, the barbecue grill apparatus may also include a bottom plate 606.

The bottom plate 606 has two wings 604, 605 and a base part 607.

The two wings 604, 605 are extended from two opposite sides of the base part 607 of the bottom plate 606.

The two wings 604, 605 respectively lean on inner sides of the first folding plate 601 and the second folding plate 602 to keep the first folding plate 601 and the second folding plate 602 to spread in the open mode.

In some embodiments, the base part 607 of the bottom plate 606 is a water tray for holding water.

In some embodiments, two wind shielding plates 610 with trapezoidal shape are placed on two opposite sides of the base part 607 to form an expanding structure to keep the first folding plate 601 and the second folding plate 602 to spread in the open mode.

When the bottom plate 606 is placed into the spreading space between the first folding plate 601 and the second folding plate 602, the bottom plate 606 falls by gravity and stop by the first folding plate 601 and the second folding plate 602, and thus keep the spreading angle fixed.

In some embodiments, the two wind shielding plates 610 are detached from the bottom plate 606 to collapse the bottom plate 606.

In other words, the bottom plate 606 may be folded to collapse to a smaller size for convenient storage.

In some embodiments, there are two cavities 6091 respectively on top side of the two wind shielding plates 610 for disposing a grill lever 609.

In some embodiments, the two wings 604, 605 are rotatable with respect to the base part 607 to collapse the bottom plate 606, which makes it to have a much smaller size to storage.

In some embodiments, two elongated holding plates 671, 672 are respectively on inner sides of the two wings 604, 605.

The grill bracket 608 is placed upon the two elongated holding plates 671, 672.

In some embodiments, a first inner surface of the first folding plate and a second inner surface of the second folding plate are used for shielding oil dropped on the first inner surface and the second inner surface.

In some embodiments, a temperature sensor 681 is disposed on the first folding plate 601 to detect a grill temperature.

In some embodiments, when a detected temperature of the temperature sensor is larger than a first threshold, the first heater 617 is stopped to be heated.

In some embodiments, in the close mode, the first folding plate 601 and the second folding plate 602 are stacked one another.

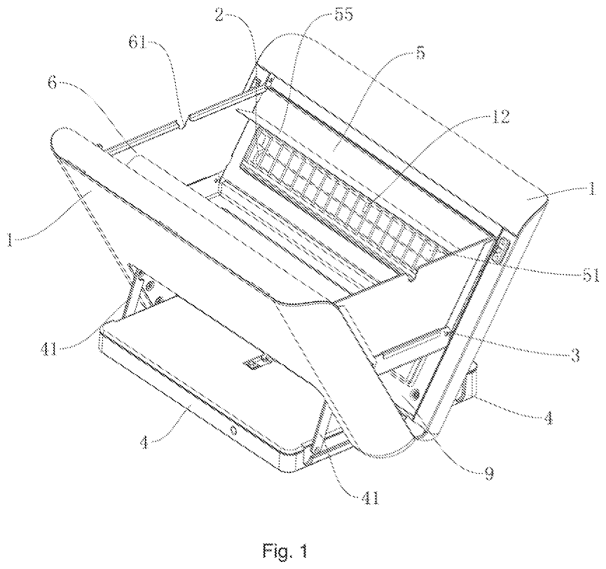

Please refer to FIG. 1, which shows a barbecue grill apparatus.

In FIG. 1, the barbecue grill apparatus includes a heater 2, an oil shielding cover 5, a temperature sensor 12, two folding plates 1, a mesh 1, a water tray 3, two bottom supports 4, two fixing levers 41, two wind shielding plates 6, cavity 61 on the wind shielding plate 6, a spreading space 9.

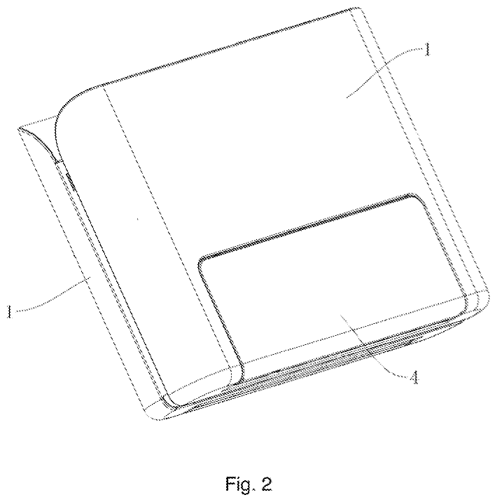

FIG. 2 shows a close mode and the same reference numerals among drawings refer to same components.

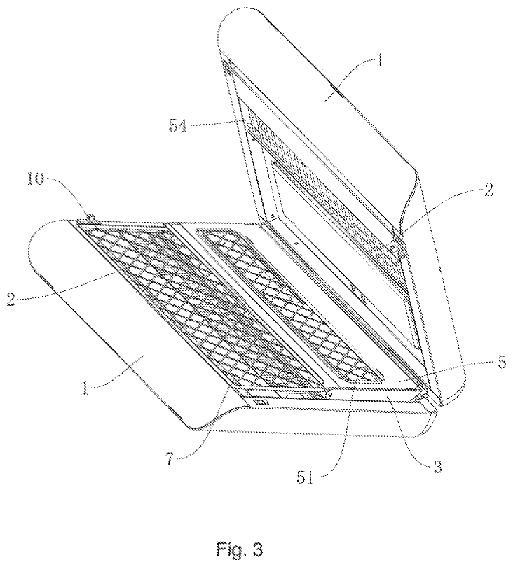

FIG. 3 shows another view of the barbecue grill apparatus. In addition the components explained above, a net plate 10 is used for holding food to be grilled. The container 7 is used for holding the heater 2. There are holes 51 for passing heat of the heater 2.

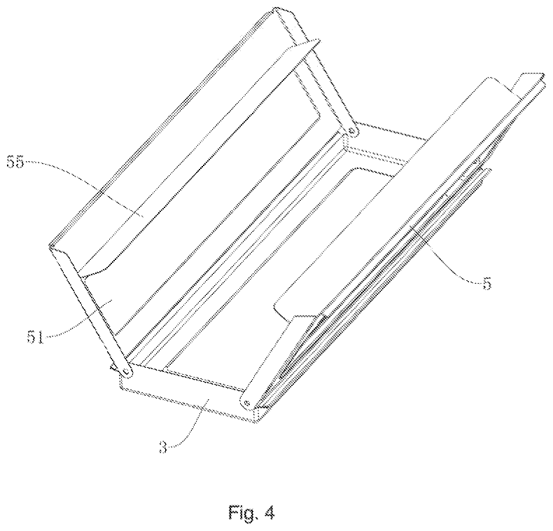

FIG. 4 shows the water tray 3 that has two elongated plates 55 for holding a grill bracket. There are holes 51 for passing heat of the heater.

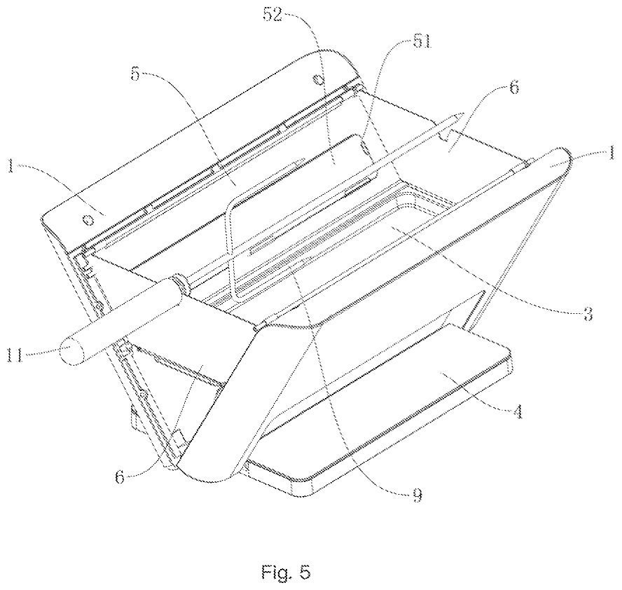

FIG. 5 shows another view by placing a grill lever 11. Other components are explained above and are not repeated again for brevity.

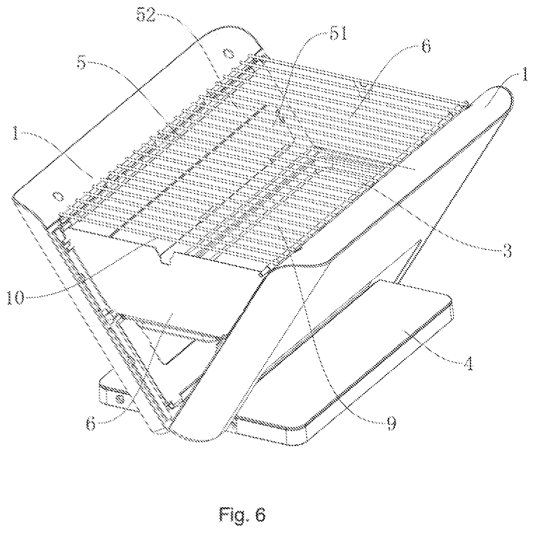

FIG. 6 shows another way to use the barbecue grill apparatus. In FIG. 6, a net plate 10 is placed on two elongated plates of the folding plates 1.

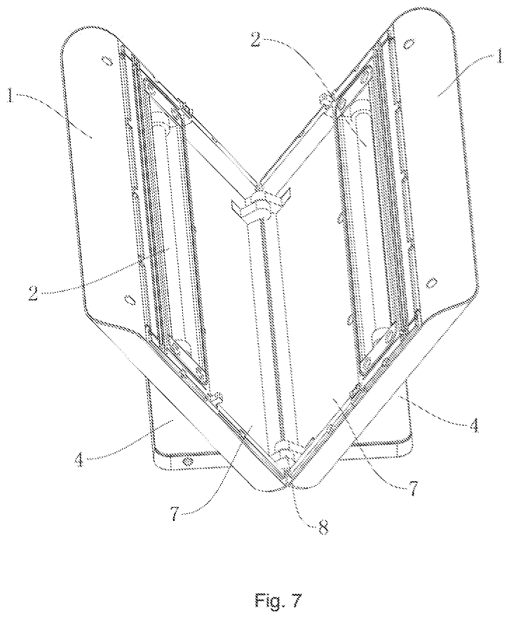

FIG. 7 shows another view of the embodiment mentioned above. The rotating connector is a hinge 8.

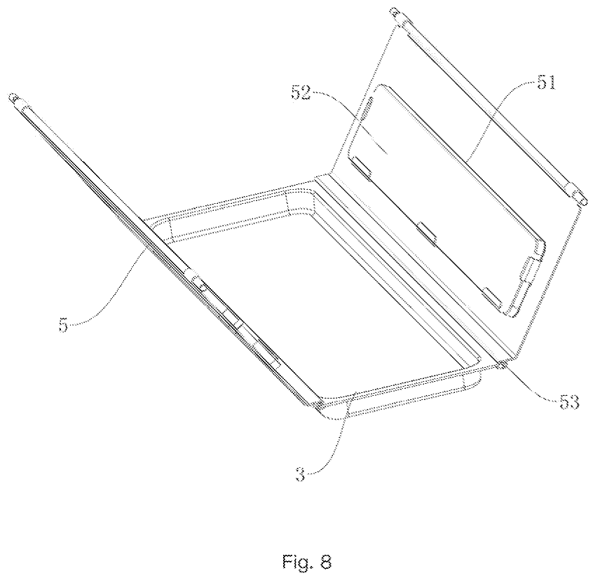

FIG. 8 shows another example of a bottom plate. In FIG. 8, there is a transparent cover 52 on the wings. The wings are coupled to the base plate via grooves 63.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings.

The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

1. A barbecue grill apparatus, comprising:
a first folding plate with a first top part, a first middle part and a first bottom part;
a second folding plate with a second top part, a second middle part and a second bottom part;
a rotating connector for connecting the first bottom part and the second bottom part for the first folding plate and the second folding plate to rotate along the rotating connector to spread with a first angle to be an open mode and to rotate along the rotating connector to collapse with a second angle to a close mode, wherein in the open mode, a grill bracket is placed between the first folding plate and the second folding plate; and
a first heater placed in the first middle part to emit heat toward the grill bracket.

2. The barbecue grill apparatus of claim 1, further comprising a second heater placed in the second middle part to emit heat toward the grill bracket.

3. The barbecue grill apparatus of claim 2, wherein a first mesh is placed upon the first heater and a second mesh is placed upon the second heater for heat of the first heater and the second heater to emit heat passing through the first mesh and the second mesh toward the grill bracket.

4. The barbecue grill apparatus of claim 2, wherein the first heater and the second heater receives electrical power to generate heat.

5. The barbecue grill apparatus of claim 2, wherein far-infrared reflecting material is applied on inner side of the first folding plate and the second folding plate.

6. The barbecue grill apparatus of claim 1, further comprising a first bottom support and a second bottom support respectively disposed on outer side of the first bottom part of the first folding plate and the second bottom part of the second folding plate, wherein the first bottom support and the second bottom support are extended to stand on a bottom surface to keep a folding space defined by the first folding plate and the second folding plate in the open mode with an opening facing upwardly.

7. The barbecue grill apparatus of claim 6, wherein the first bottom support and the second bottom support are rotated with respect to the first folding plate and the second folding plate to spread for standing on the bottom surface.

8. The barbecue grill apparatus of claim 7, wherein the first bottom support is rotatable to be collected in a first exterior container of the first bottom part of the first folding plate in the close mode, wherein the second bottom support is routable to be collected in a second exterior container of the second bottom part of the second folding plate in the close mode.

9. The barbecue grill apparatus of claim 7, wherein a first bottom fixing lever has two ends respectively fixed to the first folding plate and the first bottom support and a second bottom fixing lever has two ends respectively fixed to the second folding plate and the second bottom support to keep the first bottom support and the second bottom support to spread.

10. The barbecue grill apparatus of claim 1, further comprising a bottom plate, wherein the bottom plate has two wings and a base part, wherein the two wings are extended from two opposite sides of the base part of the bottom plate, wherein the two wings respectively leaning on inner sides of the first folding plate and the second folding plate to keep the first folding and the second folding plate to spread in the open mode.

11. The barbecue grill apparatus of claim 10, wherein the base part of the bottom plate is a water tray for holding water.

12. The barbecue grill apparatus of claim 10, wherein two wind shielding plates with trapezoidal shape are placed on two opposite sides of the base part to form an expanding structure to keep the first folding plate and the second folding plate to spread in the open mode.

13. The barbecue grill apparatus of claim 12, wherein the two wind shielding plates are detached from the bottom plate to collapse the bottom plate.

14. The barbecue grill apparatus of claim 12, wherein there are two cavities respectively on top side of the two wind shielding plates for disposing a grill lever.

15. The barbecue grill apparatus of claim 10, wherein the two wings are rotatable with respect to the base part to collapse the bottom plate.

16. The barbecue grill apparatus of claim 15, wherein two elongated holding plates are respectively on inner sides of the two wings, wherein the grill bracket is placed upon the two elongated holding plates.

17. The barbecue grill apparatus of claim 1, wherein a first inner surface of the first folding plate and a second inner surface of the second folding plate are used for shielding oil dropped on the first inner surface and the second inner surface.

18. The barbecue grill apparatus of claim 1, wherein a temperature sensor is disposed on the first folding plate to detect a grill temperature.

19. The barbecue grill apparatus of claim 18, wherein when a detected temperature of the temperature sensor is larger than a first threshold, the first heater is stopped to be heated.

20. The barbecue grill apparatus of claim 1, wherein in the close mode, the first folding plate and the second folding plate are stacked one another.
